(19) United States
(12) Patent Application Publication
(10) Pub. No.: US 2022/0156558 A1
(43) Pub. Date: May 19, 2022

(54) SUB-HOURLY LOAD DISAGGREGATION OF HOME APPLIANCES USING ELECTRIC SMART METER READS PROCESSED INSIDE SMART METERS

(71) Applicant: GRID4C Ltd., Tel Aviv (IL)

(72) Inventors: Eran SAMUNI, Giv'atayim (IL); Eran COHEN, Ramat Gan (IL); Alexander ZAK, Jerusalem (IL)

(21) Appl. No.: 17/099,111

(22) Filed: Nov. 16, 2020

(51) Int. Cl. G06N 3/04; G06N 3/08

(52) U.S. Cl. CPC G06N 3/0445; G06N 3/088

(57) ABSTRACT

The present invention provides a method for determining probable presence, in a surveyed household, of appliances having no load sensors, said method implemented by one or more processing devices to perform:
Acquiring at an edge device located at the house hold, the load data of the household;
Realtime compression of load measurements;
Calculating indicators which represent the measured load data, wherein the indicators provide partial representation of the measured data, wherein the partial representation include data pattern or specific type of measurement or schedule of measurement which is associated with the presence of specific type of appliances;
Transmitting the calculated indicator and compressed data from edge device to cloud server;
Applying learning algorithm at the cloud server, only on the calculated indicators for identifying presence of appliance.

### TECHNICAL FIELD

The present invention relates to the field of estimating electrical appliance consumption, and more particularly, estimating the presence and consumption of electrical appliance based on household profile and consumption behavior pattern.

### BACKGROUND ART

To track electrical consumption of individual household appliances, prior art solutions require direct measurement of each appliance using electricity consumption (“load”) sensors associated with each appliance, or alternatively, continuous smart meter measurements. The first solution requires installation of additional hardware, i.e., sensors for each appliance. The second solution requires more expensive processing resources.

The present invention provides a solution without appliance sensors and by means of common household meters providing periodic discrete consumption measurements.

### SUMMARY OF INVENTION

These, additional, and/or other aspects and/or advantages of the present invention are: set forth in the detailed description which follows; possibly inferable from the detailed description; and/or learnable by practice of the present invention.

The present invention provides a method for determining probable presence,

in a surveyed household, of appliances having no load sensors, said method implemented by one or more processing devices operatively coupled to a non-transitory storage device, on which are stored modules of instruction code that when executed cause the one or more processing devices to perform:

Acquiring at an edge device located at the house hold, the load data of the household;

Realtime compression of load measurements;

Calculating indicators which represent the measured load data, wherein the indicators provide partial representation of the measured data, wherein the partial representation include data pattern or specific type of measurement or schedule of measurement which is associated with the presence of specific type of appliances;

Transmitting the calculated indicator and compressed data from edge device to cloud server;

Applying learning algorithm at the cloud server, only on the calculated indicators for identifying presence of appliance, wherein the learning algorithm is based on:
Pre-processing per household of historical appliance consumption, based on actual measurement performed by sensors associated with said appliances in relation to profile of household including characteristics of the house and/or demographic characteristics of the occupants and environmental time dependent parameters;
Train machine learning algorithm for detecting appliance presence at each household based on at least one of: 1) household profile parameters, 2) household actual calculated indicators of consumption provided by the household device 3) household compressed actual consumption usage in relation to environmental time dependent parameters.

According to some embodiments of the present invention the indicators are determined by training process which detect indicators parameters which correspond with presences/activation/consumption of the appliance.

According to some embodiments of the present invention the method further comprising the step of training machine learning algorithm insights based on the indicator and compressed data, wherein the insights include data which represents pieces of information which indicate change in parameters, which is transferred to the edge device, the insights data improve the indicator generation algorithms. activation.

According to some embodiments of the present invention the AI algorithm creates and train an auto encoder neural network, the input of which are the consumption metrics available on the edge device, that has at least one hidden layer (code layer) with a small amount of neurons, and that is trained to produce the same output as it's input. The layers leading to the code layer are of little size and complexity, so that the edge device can apply them on it's real time measurements.

According to some embodiments of the present invention part of the neural network described above, from the input layer to the code layer is placed on the edge device, to be applied on real time measurements, where the outputs of the code layer are sent to the cloud server, as representations of the actual real time measurements.

According to some embodiments of the present invention the appliance presence AI training is implement by Applying Deep neural network such as CNN or RNN LSTM for identifying presences of appliance using compressed consumption measurements, indicators calculated on the edge, weather data and house metadata and Apply gradient boosting algorithm using results of the deep neural network, as well as it's input.

According to some embodiments of the present invention the appliance presence AI training is implement by the steps of:

Applying Deep neural network such as CNN or RNN LSTM for identifying presences of appliance using compressed consumption measurements, indicators calculated on the edge, weather data and house metadata;

Apply gradient boosting algorithm using results of the by interactive decision tress using compressed consumption measurements, indicators calculated on the edge, weather data and house metadata 640; and

Integrating results from deep neural network and gradient boosting algorithm

According to some embodiments of the present invention the appliance presence AI training is implement by Applying Deep neural network such as CNN or RNN LSTM for identifying presences of appliance using compressed consumption measurements, indicators calculated on the edge, weather data and house metadata.

According to some embodiments of the present invention the AI training algorithm for the indicators is implement by Applying decision tree forest, reduced by ensemble pruning

According to some embodiments of the present invention the AI training algorithm for the indicators is implement by Applying time series shapeletes detection algorithm to detect predefined short pattern which characterize each appliance consumption along time period

The preset invention provides a system for determining probable presence, in a surveyed household, of appliances having no load sensors, said method implemented by one or more processing devices operatively coupled to a non-transitory storage device, on which are stored modules of instruction code that when executed cause the one or more processing devices to perform:

a data API configured to acquire at an edge device located at the house hold, the load data of the household;

Indicators generation module configured for real-time compression of load measurements and calculating indicators which represent the measured load data, wherein the indicators provide partial representation of the measured data, wherein the partial representation include data pattern or specific type of measurement or schedule of measurement which is associated with the presence of specific type of appliances;

a communication module Transmitting the calculated indicator and compressed data from edge device to cloud server;

Appliance detection algorithm at the cloud server configured to apply learning algorithm, only on the calculated indicators for identifying presence of appliance, wherein the learning algorithm is based on:
Pre-processing per household of historical appliance consumption, based on actual measurement performed by sensors associated with said appliances in relation to profile of household including characteristics of the house and/or demographic characteristics of the occupants and environmental time dependent parameters;
Train machine learning algorithm for detecting appliance presence at each household based on at least one of: 1) household profile parameters, 2) household actual calculated indicators of consumption provided by the household device 3) household compressed actual consumption usage in relation to environmental time dependent parameters.

According to some embodiments of the present invention the indicators are determined by training process which detect indicators parameters which correspond with presences/activation/consumption of the appliance.

According to some embodiments of the present invention the system further comprising training machine learning algorithm modules of insights parameters based on the indicator and compressed data, wherein the insights include data which represents pieces of information which indicate change in parameters, which is transferred to the edge device, the insights data improve the indicator generation algorithms. activation.

According to some embodiments of the present invention AI algorithm creates and train an auto encoder neural network, the input of which are the consumption metrics available on the edge device, that has at least one hidden layer (code layer) with a small amount of neurons, and that is trained to produce the same output as it's input. The layers leading to the code layer are of little size and complexity, so that the edge device can apply them on it's real time measurements.

According to some embodiments of the present invention part of the neural network described above, from the input layer to the code layer is placed on the edge device, to be applied on real time measurements, where the outputs of the code layer are sent to the cloud server, as representations of the actual real time measurements.

According to some embodiments of the present invention the appliance presence AI training is implement by Applying Deep neural network such as CNN or RNN LSTM for identifying presences of appliance using compressed consumption measurements, indicators calculated on the edge, weather data and house metadata and Apply gradient boosting algorithm using results of the deep neural network, as well as it's input.

According to some embodiments of the present invention the appliance presence AI training is implement by the steps of:

Applying Deep neural network such as CNN or RNN LSTM for identifying presences of appliance using compressed consumption measurements, indicators calculated on the edge, weather data and house metadata;

Apply gradient boosting algorithm using results of the by interactive decision tress using compressed consumption measurements, indicators calculated on the edge, weather data and house metadata 640; and

Integrating results from deep neural network and gradient boosting algorithm

According to some embodiments of the present invention the appliance presence AI training is implement by Applying Deep neural network such as CNN or RNN LSTM for identifying presences of appliance using compressed consumption measurements, indicators calculated on the edge, weather data and house metadata.

According to some embodiments of the present invention the AI training algorithm for the indicators is implement by Applying decision tree forest, reduced by ensemble pruning.

According to some embodiments of the present invention the AI training algorithm for the indicators is implement by Applying time series shapeletes detection algorithm to detect predefined short pattern which characterize each appliance consumption along time period

### BRIEF DESCRIPTION OF DRAWINGS

FIG. 1 is a block diagram illustrating the modules for analyzing of household load and estimating presence, activation and consumption of appliances according to some embodiments of the present invention.

FIG. 2 is an illustration flow chart of the appliance detection Module (200) and indicator generation module 130 according to some embodiments of the present invention.

FIG. 3 is an illustration flow chart of the appliance activation and consumption Detection module 300 and measurement compression algorithm 120 according to some embodiments of the preset invention.

FIGS. 4A and 4B is an illustration flow chart of aggregation and training appliance detection module according to some embodiments of the present invention;

FIG. 5 is an illustration flow chart of the aggregation and training for indicator generation according to some embodiments of the preset invention.

FIG. 6 is an illustration flow chart of the appliance presence detection algorithm 600 according to some embodiments of the preset invention.

FIG. 7 is an illustration flow chart of the edge indicator module 700 according to some embodiments of the preset invention.

FIG. 8 is a graph example of air-conditioning consumption behavior.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides solution for detecting the presence, activation and the consumption of electric devices in the premise while leveraging the usage of 1 second data of consumption, reactive load, different phase data and other metrics available on the edge. As the calculation capability, storage, CPU and network bandwidth is very limited in the edge devices installed in the premises, it is not possible to fully use the consumption data in 1 second resolution. The present invention solution overcomes this deficiency by using unique algorithms on the edge device and on the cloud as will be further explained bellow.

The present invention provides presence and consumption detection models for household appliances, these models facilitating a determination of the presence of specific appliances, their times of activation and their electrical consumption. The invention provides the model for surveyed houses in which appliances do not have remotely monitored sensors, and in which the meter can provide global consumption data for discrete time periods. The models are based on the analysis of historical data of small sample groups of households in which sensors are installed to measure each appliance consumption.

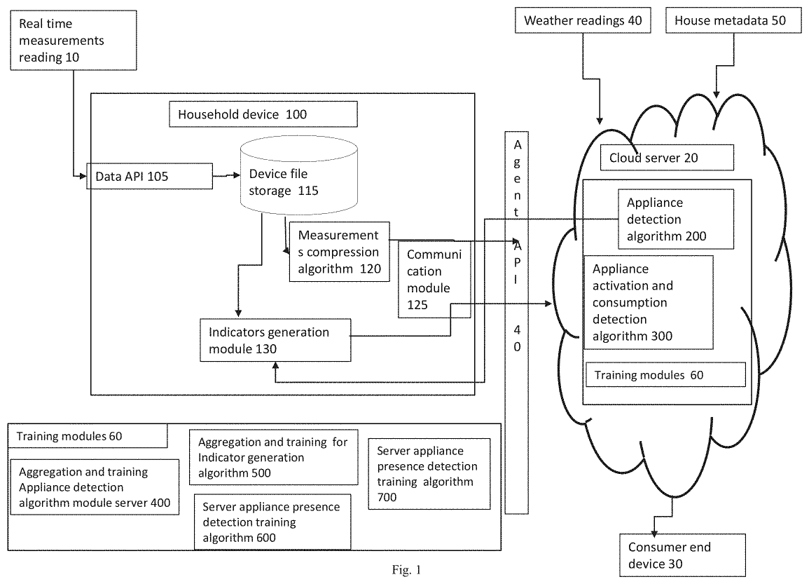

FIG. 1 is a block diagram illustrating the modules for analyzing of household load and estimating presence, activation and consumption of appliances according to some embodiments of the present invention.

The system is comprised of a household device 100 which receives real measurements of 1 second data of consumption from household meter device, collected by a data API 105 and recorded at device file storage 115. The indicator generation module 130 retrieves the data in real time from the device file storage 115 for calculating indicators which provide partial representation of the measured data, the partial representation including a data pattern or a specific type of measurement or a schedule of measurement data. The measurement compression algorithm 120 compresses in real time measurements in volume compatible with the network bandwidth. The indicators and the compressed data are transferred in real time using communication module 125 through agent API 40 to the cloud server 20. The cloud server 20 is comprised of appliances detection algorithm 200 for identifying the appliances existing in the household based on AI learning algorithm trained by the indicators and compressed data, and appliances activation and consumption module 300 configured to identify activated appliances and calculate their consumption using AI learning module, trained to use the indicators and compressed data. The cloud server 20 further comprise training modules 60, including Aggregation and training Appliance detection algorithm module server 400, Aggregation and training for Indicator generation algorithm 500, Server appliance presence detection training algorithm 600 and Server appliance presence detection training algorithm 700

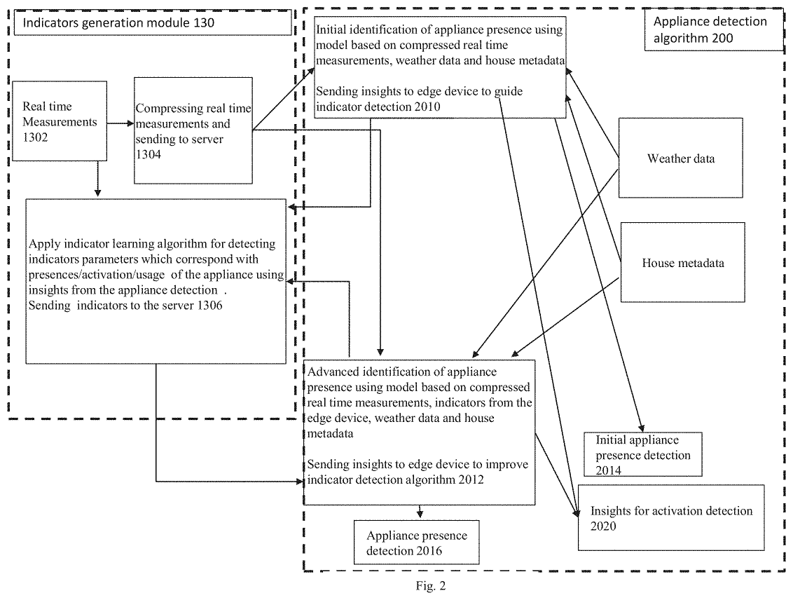

FIG. 2 is an illustration flow chart of the appliance detection Module (200) and indicator generation module 130 according to some embodiments of the present invention.

The indicator generation module 130 and compression module 120 perform at least one of the following s steps:

Receiving Real time Measurements including 1 second data of consumption 1302;

Compressing in real time the load measurements and sending to server 1304, compression will decrease resolution (for example, measurements taken every second will be aggregated to minutes) or precision (for example, consumption precise to the 0.01 watt will be converted to be precise to 1 watt), or both.

Apply indicator learning algorithm for detecting indicators parameters which correspond to presence/activation/consumption of the appliance and sending indicators to the server (1306).

The detection module 200 perform at least one of the following s steps:

Initial identification of appliance presence using model provides Initial appliance presence detection report 2014, based on compressed real time measurements, weather data and house metadata and Sending instruction to edge device to guide indicator detection (2010).

Applying advanced identification of appliance presence using AI model based on compressed real time measurements and indicators from the edge device, weather data and house metadata and sending feedback to edge device to improve indicator detection algorithm 2012.

Providing Insights for activation detection 2020, based on an AI insight model based on compressed real time measurements and indicators from the edge device

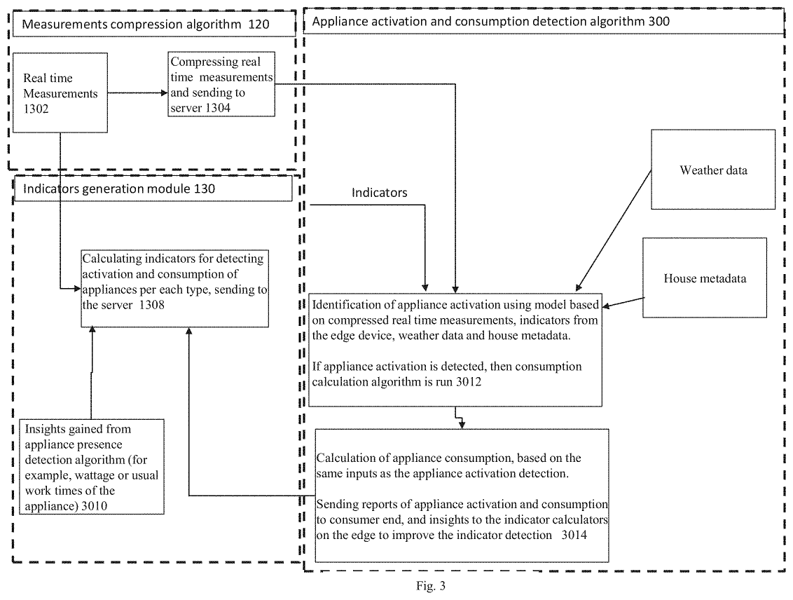

FIG. 3 is an illustration flow chart of the appliance activation and consumption Detection module 300 and measurement compression algorithm 120 according to some embodiments of the present invention.

The indicator generation module 130 and compression module 120 perform at least one of the following s steps:

Real time Measurements including 1 second data of consumption 1302.

Compressing real time measurements and sending to server 1304;

Calculating indicators for detecting activation and consumption of appliances per each type, sending to the server 1308. The indicators are calculated based on Real Time Measurements 1302, using Insights gained from appliance presence detection algorithm 3010 (for example of a possible insight, an algorithm that detects whether an appliance is present, might also calculate it's wattage and common daily activation time, which then improve the quality of indicators calculated).

Here are some examples of indicators that can be detected at the edge device to provide data for the AI algorithm that runs in the cloud:

Some appliances with rotating components, such as the washing machine and the fan require a high amount of reactive power. The edge device can detect surges in reactive power load and send the time they were detected.

In the USA and Canada, appliances with high consumption, such as electric dryers and air conditioners, are usually connected to both 120-volt wires. The consumption of the appliances is shared between them. The edge device can detect a simultaneous and equal increase or decrease in both wires, and report its time and magnitude to the cloud, to indicate that a high-consumption appliance started or stopped working.

Some appliances, when they start working, display a distinct consumption pattern that is only discernable on a 1 second level. For example, in many air conditioners the consumption jumps for 1 second to a very high value, sometimes two times or more the regular consumption of the appliance. Then it drops below regular consumption, and slowly rises to match it over the next several seconds. The edge can detect instances of this pattern and send the cloud its time and properties, which will help the cloud to detect that an air conditioner started working.

The Appliance activation and consumption detection algorithm 300, performs at least one of the following s steps:

Identification of appliance activation using model based on compressed real time measurements, indicators from the edge device, weather data and house metadata.

If appliance activation is detected, then consumption calculation algorithm is run 3012.

Calculation of appliance consumption, based on the same inputs as the appliance activation detection.

Sending reports of appliance activation and consumption to consumer end, and insights to the indicator calculators on the edge to improve the indicator detection 3014.

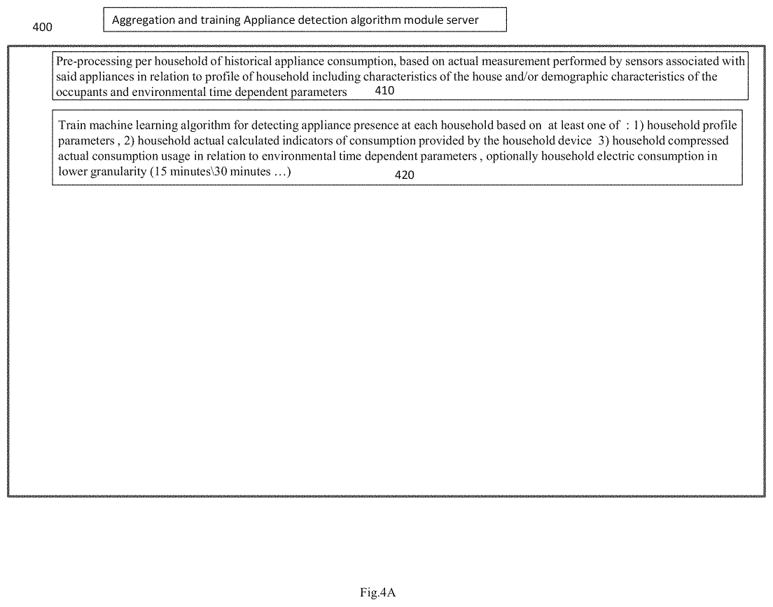

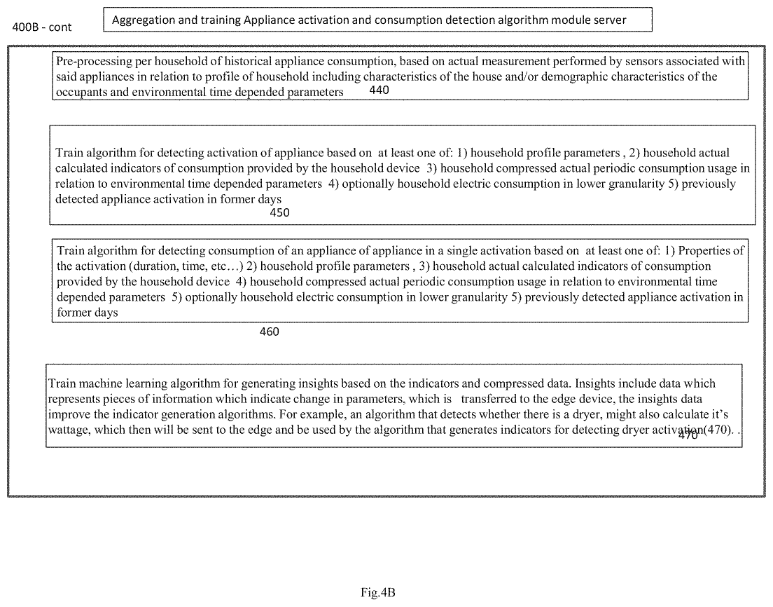

FIG. 4A is an illustration flow chart of aggregation and training appliance detection module according to some embodiments of the preset invention;

The aggregation and training appliance detection module perform at least one of the following s steps:

Pre-processing per household of historical appliance consumption, based on actual measurement performed by sensors associated with said appliances in relation to profile of household including characteristics of the house and/or demographic characteristics of the occupants and environmental time dependent parameters 410;

Train machine learning algorithm for detecting appliance presence at each household based on at least one of: 1) household profile parameters, 2) household actual calculated indicators of consumption provided by the household device 3) household compressed actual consumption usage in relation to environmental time dependent parameters, optionally household electric consumption in lower granularity (15 minutes\30 minutes . . . ) 420.

The term ‘consumption’ may include other measurements performed, not necessarily only consumption, at the edge device (for example phase angle, indoor temperature, etc).

FIG. 4B is an illustration flow chart of aggregation and training appliance activation and consumption detection module according to some embodiments of the preset invention;

The activation and consumption detection module performs at least one of the following steps:

Pre-processing per household of historical appliance consumption, based on actual measurement performed by sensors associated with said appliances in relation to profile of household including characteristics of the house and/or demographic characteristics of the occupants and environmental time depended parameters (440).

Train algorithm for detecting activation of appliance based on at least one of: 1) household profile parameters, 2) household actual calculated indicators of consumption provided by the household device 3) household compressed actual periodic consumption usage in relation to environmental time depended parameters 4) optionally household electric consumption in lower granularity 5) previously detected appliance activation in former days (450)

Train algorithm for detecting consumption of an appliance in a single activation based on at least one of: 1) Properties of the activation (duration, time, etc . . . ) 2) household profile parameters, 3) household actual calculated indicators of consumption provided by the household device 4) household compressed actual periodic consumption usage in relation to environmental time depended parameters 5) optionally household electric consumption in lower granularity 6) previously detected appliance activation in former days (460).

Train machine learning algorithm for generating insights based on the indicators and compressed data. Insights include data which represents pieces of information which indicate change in parameters, which is transferred to the edge device, the insights data improve the indicator generation algorithms. For example, an algorithm that detects whether there is a dryer, might also calculate it's wattage, which then will be sent to the edge and be used by the algorithm that generates indicators for detecting dryer activation (470).

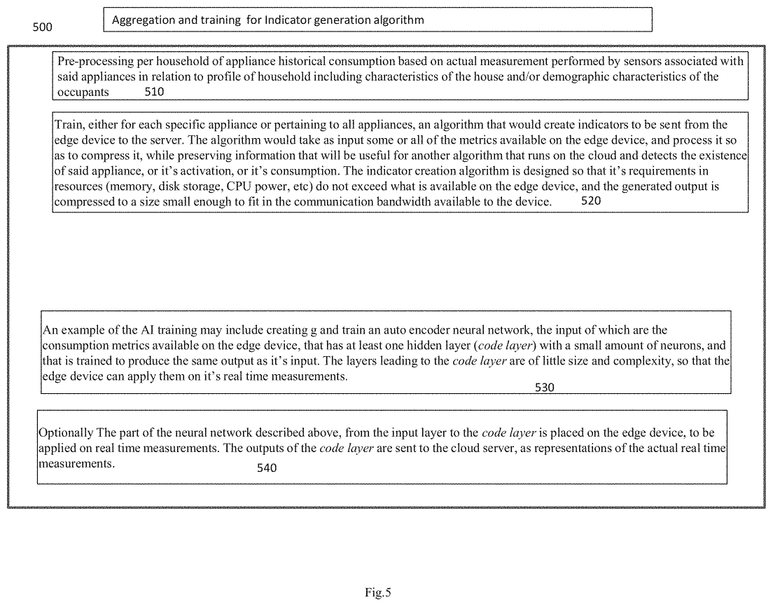

FIG. 5 is an illustration flow chart of the aggregation and training for indicator generation algorithm according to some embodiments of the present invention.

The aggregation and training for indicator module perform at least one of the following s steps:

Pre-processing per household of appliance historical consumption based on actual measurement performed by sensors associated with said appliances in relation to profile of household including characteristics of the house and/or demographic characteristics of the occupants 510

Train, either for each specific appliance or pertaining to all appliances, an AI algorithm that would create indicators to be sent from the edge device to the server. The algorithm can take as input some or all of the metrics available on the edge device, and process it so as to compress it, while preserving information that will be useful for another algorithm that runs on the cloud and detects the existence of said appliance, or it's activation, or it's consumption. The indicator creation algorithm is designed so that it's requirements in resources (memory, disk storage, CPU power, etc) do not exceed what is available on the edge device, and the generated output is compressed to a size small enough to fit in the communication bandwidth available to the device 520;

The AI algorithm may create and train an auto encoder neural network, the input of which are the consumption metrics available on the edge device, that has at least one hidden layer (code layer) with a small amount of neurons, and that is trained to produce the same output as it's input. The layers leading to the code layer are of little size and complexity, so that the edge device can apply them on it's real time measurements 530;

According to some embodiments of the present invention, the part of the neural network described above, from the input layer to the code layer is placed on the edge device, to be applied on real time measurements. The outputs of the code layer are sent to the cloud server, as representations of the actual real time measurements. 540

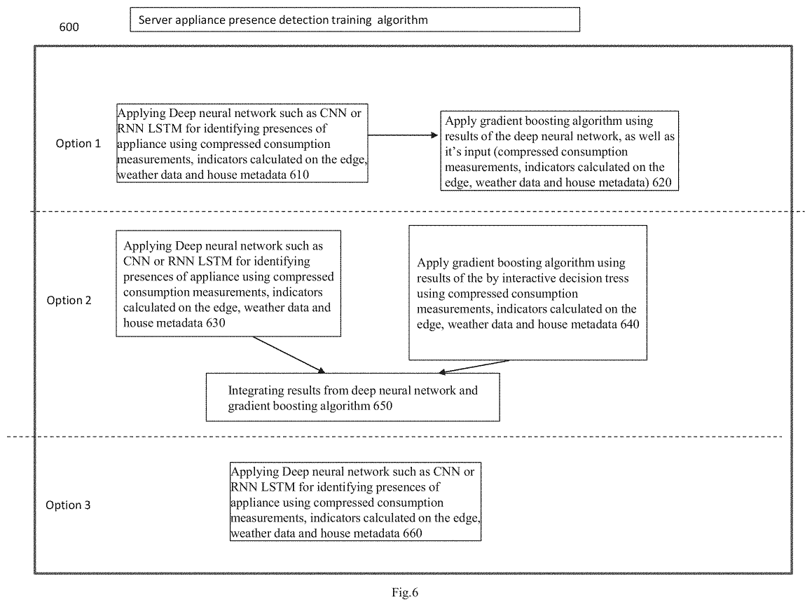

FIG. 6 is an illustration flow chart of the appliance presence AI algorithm 600 according to some embodiments of the present invention.

The appliance presence AI training algorithm may be implemented in different methods:

### Option 1

Applying Deep neural network such as CNN or RNN LSTM for identifying presences of appliance using compressed consumption measurements, indicators calculated on the edge, weather data and house metadata 610

Apply gradient boosting algorithm using results of the deep neural network, as well as it's input (compressed consumption measurements, indicators calculated on the edge, weather data and house metadata) 620.

### Option 2

Applying Deep neural network such as CNN or RNN LSTM for identifying presences of appliance using compressed consumption measurements, indicators calculated on the edge, weather data and house metadata 630.

Apply gradient boosting algorithm using results of the by interactive decision tress using compressed consumption measurements, indicators calculated on the edge, weather data and house metadata 640.

Integrating results from deep neural network and gradient boosting algorithm 650.

### Option 3

Applying Deep neural network such as CNN or RNN LSTM for identifying presences of appliance using compressed consumption measurements, indicators calculated on the edge, weather data and house metadata 660/

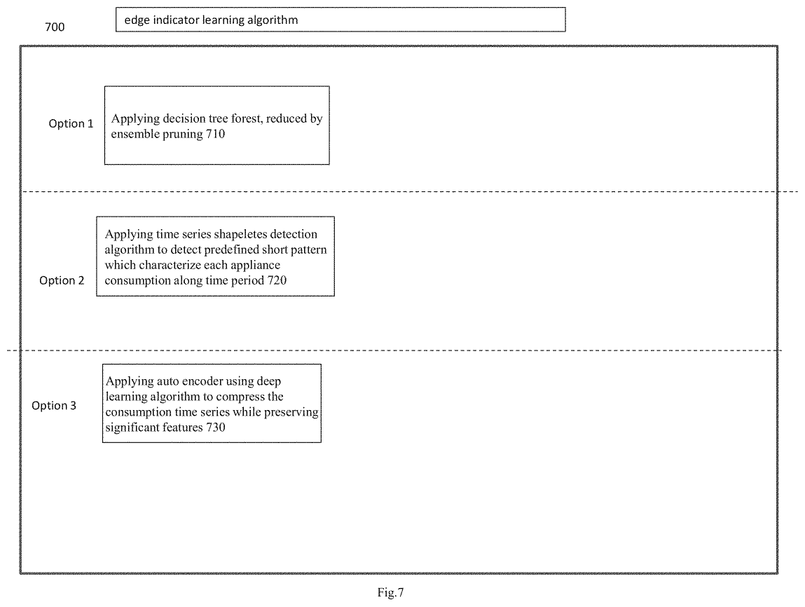

FIG. 7 is an illustration flow chart of the edge indicator module 700 according to some embodiments of the present invention.

The AI training algorithm for the indicators may be implemented in different methods:

### Option 1

Applying decision tree forest, reduced by ensemble pruning 710;

### Option 2

Applying time series shapeletes detection algorithm to detect predefined short pattern which characterize each appliance consumption along time period 720.

### Option 3

Applying auto encoder using deep learning algorithm to compress the consumption time series while preserving significant features 730

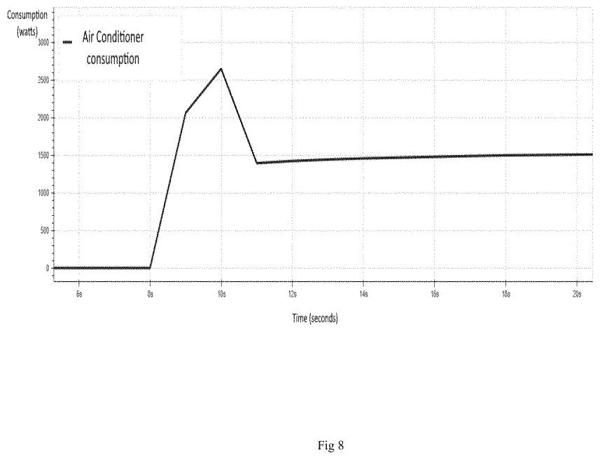

FIG. 8 is a graph example of air-conditioning consumption behavior showing data pattern which can used as indicator.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for determining probable presence, in a surveyed household, of appliances having no load sensors, said method implemented by one or more processing devices operatively coupled to a non-transitory storage device, on which are stored modules of instruction code that when executed cause the one or more processing devices to perform:
Acquiring at an edge device located at the house hold, the load data of the household;
Realtime compression of load measurements;
Calculating indicators which represent the measured load data, wherein the indicators provide partial representation of the measured data, wherein the partial representation include data pattern or specific type of measurement or schedule of measurement which is associated with the presence of specific type of appliances;
Transmitting the calculated indicator and compressed data from edge device to cloud server;
Applying learning algorithm at the cloud server, only on the calculated indicators for identifying presence of appliance, wherein the learning algorithm is based on:
Pre-processing per household of historical appliance consumption, based on actual measurement performed by sensors associated with said appliances in relation to profile of household including characteristics of the house and/or demographic characteristics of the occupants and environmental time dependent parameters;
Train machine learning algorithm for detecting appliance presence at each household based on at least one of: 1) household profile parameters, 2) household actual calculated indicators of consumption provided by the household device 3) household compressed actual consumption usage in relation to environmental time dependent parameters.

2. The method of claim 1 wherein the indicators are determined by training process which detect indicators parameters which correspond with presences/activation/consumption of the appliance.

3. The method of claim 1 further comprising the step of training machine learning algorithm insights based on the indicator and compressed data, wherein the insights include data which represents pieces of information which indicate change in parameters, which is transferred to the edge device, the insights data improve the indicator generation algorithms activation.

4. The method of claim 1 The AI algorithm creates and train an auto encoder neural network, the input of which are the consumption metrics available on the edge device, that has at least one hidden layer (code layer) with a small amount of neurons, and that is trained to produce the same output as it's input. The layers leading to the code layer are of little size and complexity, so that the edge device can apply them on it's real time measurements.

5. The method of claim 4 wherein part of the neural network described above, from the input layer to the code layer is placed on the edge device, to be applied on real time measurements, where the outputs of the code layer are sent to the cloud server, as representations of the actual real time measurements.

6. The method of claim 1 wherein the appliance presence AI training is implement by Applying Deep neural network such as CNN or RNN LSTM for identifying presences of appliance using compressed consumption measurements, indicators calculated on the edge, weather data and house metadata and Apply gradient boosting algorithm using results of the deep neural network, as well as it's input.

7. The method of claim 1 wherein the appliance presence AI training is implemented by the steps of:
Applying Deep neural network such as CNN or RNN LSTM for identifying presences of appliance using compressed consumption measurements, indicators calculated on the edge, weather data and house metadata;
Apply gradient boosting algorithm using results of the by interactive decision tress using compressed consumption measurements, indicators calculated on the edge, weather data and house metadata 640; and
Integrating results from deep neural network and gradient boosting algorithm

8. The method of claim 1 wherein the appliance presence AI training is implement by Applying Deep neural network such as CNN or RNN LSTM for identifying presences of appliance using compressed consumption measurements, indicators calculated on the edge, weather data and house metadata.

9. The method of claim 1 wherein the AI training algorithm for the indicators is implement by Applying decision tree forest, reduced by ensemble pruning

10. The method of claim 1 wherein the AI training algorithm for the indicators is implement by Applying time series shapeletes detection algorithm to detect predefined short pattern which characterize each appliance consumption along time period

11. A system for determining probable presence, in a surveyed household, of appliances having no load sensors, said system implemented by one or more processing devices operatively coupled to a non-transitory storage device, on which are stored modules comprising:
a data API configured to acquire at an edge device located at the house hold, the load data of the household;
Indicators generation module configured for real-time compression of load measurements and calculating indicators which represent the measured load data, wherein the indicators provide partial representation of the measured data, wherein the partial representation include data pattern or specific type of measurement or schedule of measurement which is associated with the presence of specific type of appliances;
a communication module Transmitting the calculated indicator and compressed data from edge device to cloud server;
Appliance detection algorithm at the cloud server configured to apply learning algorithm, only on the calculated indicators for identifying presence of appliance, wherein the learning algorithm is based on:
Pre-processing per household of historical appliance consumption, based on actual measurement performed by sensors associated with said appliances in relation to profile of household including characteristics of the house and/or demographic characteristics of the occupants and environmental time dependent parameters;
Train machine learning algorithm for detecting appliance presence at each household based on at least one of: 1) household profile parameters, 2) household actual calculated indicators of consumption provided by the household device 3) household compressed actual consumption usage in relation to environmental time dependent parameters.

12. The system of claim 11 wherein the indicators are determined by training process which detect indicators parameters which correspond with presences/activation/consumption of the appliance.

13. The system claim 11 further comprising training machine learning algorithm modules of insights parameters based on the indicator and compressed data, wherein the insights include data which represents pieces of information which indicate change in parameters, which is transferred to the edge device, the insights data improve the indicator generation algorithms. activation.

14. The system of claim 11 wherein AI algorithm creates and train an auto encoder neural network, the input of which are the consumption metrics available on the edge device, that has at least one hidden layer (code layer) with a small amount of neurons, and that is trained to produce the same output as it's input. The layers leading to the code layer are of little size and complexity, so that the edge device can apply them on it's real time measurements.

15. The system of claim 14 wherein part of the neural network described above, from the input layer to the code layer is placed on the edge device, to be applied on real time measurements, where the outputs of the code layer are sent to the cloud server, as representations of the actual real time measurements.

16. The system of claim 11 wherein the appliance presence AI training is implement by Applying Deep neural network such as CNN or RNN LSTM for identifying presences of appliance using compressed consumption measurements, indicators calculated on the edge, weather data and house metadata and Apply gradient boosting algorithm using results of the deep neural network, as well as it's input.

17. The system of claim 11 wherein the appliance presence AI training is implement by the steps of:
Applying Deep neural network such as CNN or RNN LSTM for identifying presences of appliance using compressed consumption measurements, indicators calculated on the edge, weather data and house metadata;
Apply gradient boosting algorithm using results of the by interactive decision tress using compressed consumption measurements, indicators calculated on the edge, weather data and house metadata 640; and
Integrating results from deep neural network and gradient boosting algorithm

18. The system of claim 11 wherein the appliance presence AI training is implement by Applying Deep neural network such as CNN or RNN LSTM for identifying presences of appliance using compressed consumption measurements, indicators calculated on the edge, weather data and house metadata.

19. The system of claim 11 wherein the AI training algorithm for the indicators is implement by Applying decision tree forest, reduced by ensemble pruning.

20. The system of claim 11 wherein the AI training algorithm for the indicators is implement by Applying time series shapeletes detection algorithm to detect predefined short pattern which characterize each appliance consumption along time period
